(19) United States
(12) Patent Application Publication
(10) Pub. No.: US 2006/0053066 A1
(43) Pub. Date: Mar. 9, 2006

(54) Online digital video signal transfer apparatus and method

(76) Inventors: Scott Jeffrey Sherr, Los Angeles, CA (US); Eva Miranda, Saratoga, CA (US); Ira Steven Rubenstein, Los Angeles, CA (US); Sean Brennan Carey, Marina del Rey, CA (US); Yair Landau, Pacific Palisades, CA (US); Andrew C. Frank, New York, NY (US); Brian David Lakamp, Malibu, CA (US); Bryan Gentry Spaulding, San Francisco, CA (US); Charles Jonathan Evans, New York, NY (US); Everton Anthony Schnabel, Los Angeles, CA (US); Hartmut Ochs, Los Angeles, CA (US); Jeremy Eli Barnett, Pacific Palisades, CA (US); Seth David Palmer, New York, NY (US); Todd Michael Henderson, Los Angeles, CA (US); William W. Chong, New York, NY (US); Steven Koenig, Menlo Park, CA (US); Bruce Forest, Weston, CT (US)

Correspondence Address: SIDLEY AUSTIN BROWN & WOOD LLP (LAIP GROUP), 555 W. FIFTH ST., SUITE 4000, LOS ANGELES, CA, 90013, US

(21) Appl. No.: 11/158,038

(22) Filed: Jun. 20, 2005

Related U.S. Application Data
(63) Continuation of application No. 09/826,323, filed on Apr. 4, 2001, now abandoned.
(60) Provisional application No. 60/195,870, filed on Apr. 7, 2000.

(51) Int. Cl. G06Q 30/00

(52) U.S. Cl. 705/26

(57) ABSTRACT

The present invention overcomes the problems in the existing art described above by providing an online digital video signal transfer apparatus and method. Rental of the digital video signals occurs within an online environment including one or more client computers and at least one network server connected by a communications link to the one or more client computers. The method includes providing access to an online catalog stored within a memory of a network video server computer. The online catalog includes information regarding digital video signals available for rental from the network server computer. Requests are then received from client computers for rental of digital video signals selected from the online catalog for a specified period of time. The requests include electronic payment based on the selected digital video signal and the specified period of time. Once electronic payment is provided, the digital video signal is transmitted to the client computer via communications link. Once transmitted, the digital video signal is viewable by a user of the client computer during the specified period of time. Advantages of the invention include the ability to rent motion pictures without having to provide additional monies for purchase of the motion pictures. In addition, the present invention provides an interface that simulates the actual rental of motion pictures within a video rental store. Moreover, during the specified period of rental, the user is allowed to view the motion picture as many times as desired, thereby simulating the actual rental of video cassettes or DVDs of feature length motion pictures.

### REFERENCE TO RELATED APPLICATIONS

This application claims priority to Provisional Application No. 60/195,870, filed Apr. 7, 2000, which is hereby incorporated by reference. The present invention also relates to U.S. patent application Ser. No. 09/603,805, filed Jun. 20, 2000 (for which a Petition to Convert Non-Provisional Application to Provisional Application Under 37 CFR 1.53(c)(2) was filed Mar. 16, 2001 via U.S. Express Mail Label No. EL752586903US, our file number 041892-0208, decision of petition and provisional serial number unknown at this time), is incorporated herein by reference.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The invention relates generally to the field of electronic commerce. More particularly, the invention relates to an online digital video signal transfer method and apparatus enabling online rental of digitally encoded motion pictures.

### BACKGROUND OF THE INVENTION

The Internet has provided consumers with a new medium for commerce, commonly referred to as electronic commerce (or Ecommerce). Currently there exists several Internet services that provide consumers with access to motion pictures that can be ordered and downloaded online.

U.S. Pat. No. 5,966,400, assigned to Sight Sound Incorporated, describes a system and method for transmitting desired digital video signals or digital audio signals. The patent describes a method for transferring desired digital video or audio signals through telecommunication lines between a first memory of a first party and a second memory of a second party. Once the connection is formed between the first party and the second party, the first party electronically sells the digital video or digital audio signal to the second party. Once the sale is complete, the desired digital video or digital audio signal is transferred from the first memory of the first party to the second memory of the second party. Assuming a user has downloaded a motion picture in the form of a digital video signal, the user can now freely view the motion picture on his or her home computer as many times as desired. However, for individuals that do not wish to purchase a motion picture, video-on-demand provides another option.

Tranz-Send Business Network is a further online provider of video-on-demand (VOD) motion pictures. Tranz-Send Business Network (TSBN) has created a complete end-to-end web based video-on-demand solution that delivers a full screen broadcast quality electronic content to the end user on demand. However, a user has relatively little control over VOD movies such as pause and rewind features. In addition, a fee is required each time the user desires to view the movie once the broadcast is complete.

Consequently, neither Sight Sound Inc. nor TSBN provides users with the capability for online rental of motion pictures for a fixed period, such that during the fixed period the user is allowed to replay the motion picture as many times as desired. Moreover, neither Sight Sound nor TSBN provide an interface that simulates the rental of motion pictures from racks of aisles within a video rental store.

Therefore, there remains a need to overcome the limitations on the above described existing art which is satisfied by the inventive structure and method described hereinafter.

### SUMMARY OF THE INVENTION

The present invention overcomes the problems in the existing art described above by providing an online digital video signal transfer apparatus and method. Rental of the digital video signals occurs within an online environment including one or more client computers and at least one network server connected by a communications link to the one or more client computers. The method includes providing access to an online catalog stored within a memory of a network video server computer. The online catalog includes information regarding digital video signals available for rental from the network server computer. Requests are then received from client computers for rental of digital video signals selected from the online catalog for a specified period of time. The requests include electronic payment based on the selected digital video signal and the specified period of time. Once electronic payment is provided, the digital video signal is transmitted to the client computer via communications link. Once transmitted, the digital video signal is viewable by a user of the client computer during the specified period of time.

Advantages of the invention include the ability to rent motion pictures without having to provide additional monies for purchase of the motion pictures. In addition, the present invention provides an interface, which simulates the actual rental of motion pictures within a video rental store. Moreover, during the specified period of rental, the user is allowed to view the motion picture as many times as desired, thereby simulating the actual rental of feature length motion pictures.

### BRIEF DESCRIPTION OF THE DRAWINGS

The present invention is illustrated by way of example, and not by way of limitation, in the figures of the accompanying drawings and in which:

FIG. 1 is a simplified view of an exemplary client-server environment in which the present invention may be implemented.

FIG. 2 depicts an exemplary high-level system architecture implementation of the present invention.

FIG. 3 is a block diagram of the client computer and the network video server as shown in FIG. 2.

FIGS. 4-8 depict exemplary online video transfer site screens that enable online rental of digital video signals according to one embodiment of the present invention.

FIGS. 9-11 are flow diagrams illustrating online rental of digital video signals according exemplary embodiments of the present invention.

### DETAILED DESCRIPTION

The present invention overcomes the problems in the existing art described above by providing an online digital video signal transfer apparatus and method, thereby enabling online rental of digitally encoded motion pictures. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

A movie transfer apparatus and method for providing data stored on a computer system to a user across a network connection are described in the following disclosure. The transfer can be accomplished in various ways, including, but not limited to, download, streaming, or a combination, across various types of connections, including, but not limited to, the Internet, private or public networks, direct wire or fiber connections, wireless connections, broadcast systems (e.g., cable systems, satellite systems, broadcast television system, broadcast digital television systems) or a combination of connections.

The present disclosure also describes many aspects of handling electronic files. For clarity, the description focuses on implementations for digital video signals which include digitally encoded movies (referred to as “movies”), rather than repeatedly enumerating variations. However, many or all of the methods and apparatus described can be readily adapted to apply to electronic files of other types as well, such as digitally encoded songs, books, television programming, radio programming, and any other content (audio, video, text, etc.) which can be digitized or encoded and stored as an electronic file.

Similarly, the description focuses on implementations for a network video server computer system accessible through the World Wide Web and the Internet as a website (referred to as the “MovieFly website”). However, many or all of the methods and apparatus described can be readily adapted to other data connections as well, including, but not limited to, other Internet connection interfaces (e.g., an FTP server), private networks (e.g., a network provided by an ISP for its subscribers), and direct connections (such as a directly wired set of stations in a limited area such as a hotel).

In addition, the description focuses on implementations where the user accesses and downloads electronic files using a computer system. However, many or all of the methods and apparatus described can be readily adapted to other devices which the user can use to access and download data from the server as well, such as a television with a connected cable modem and hard disk, or some other device with a network connection which can access the server and a storage device for storing a downloaded file. Additional variations can also be implemented such as interfaces for wireless, set-top-boxes (STBs), PDAs, AVHDD devices (such as a SONY “Tivo” device).

Any necessary adaptations will be apparent to those of ordinary skill in the art. The movie transfer system can be implemented in hardware, software, or a combination of both.

In addition, as will be described in greater detail below, the present invention includes features that seek to simulate the traditional rental of motion pictures from a video rental store. According to one embodiment, rental of the digital video signals occurs within an online environment including a plurality of client computers and at least one network server connected by a communications link to the plurality of client computers. The method includes providing access to an online catalog stored within a memory of a network video server computer. The online catalog includes information regarding digital video signals available for rental from the network server computer. Requests are then received from client computers for rental of digital video signals selected from the online catalog for a specified period of time. The requests include electronic payment based on the selected digital video signal and the specified period of time. Once electronic payment is provided, the digital video signal is transmitted to the client computer via communications link. Once transmitted, the digital video signal is viewable by a user of the client computer during the specified period of time.

In the preferred embodiment, the steps of the present invention are embodied in machine-executable instructions. The instructions can be used to cause a general-purpose or special-purpose processor that is programmed with the instructions to perform the steps of the present invention. Alternatively, the steps of the present invention might be performed by specific hardware components that contain hardwired logic for performing the steps, or by any combination of programmed computer components and custom hardware components.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMS, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

System Architecture

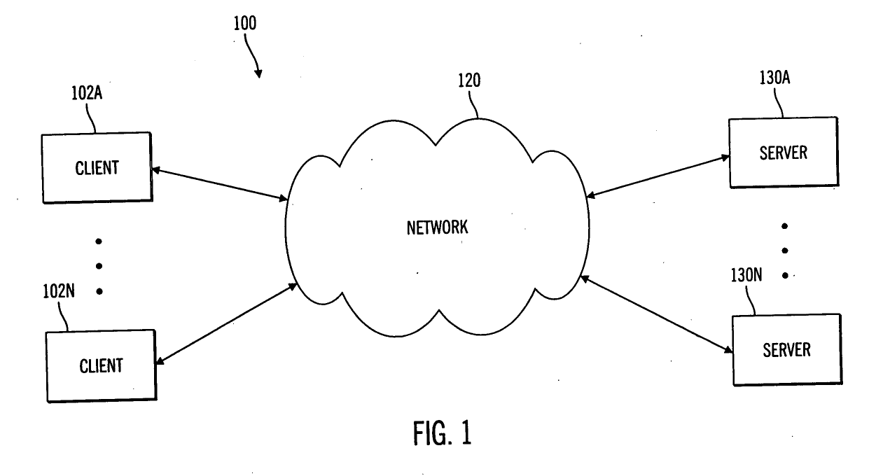

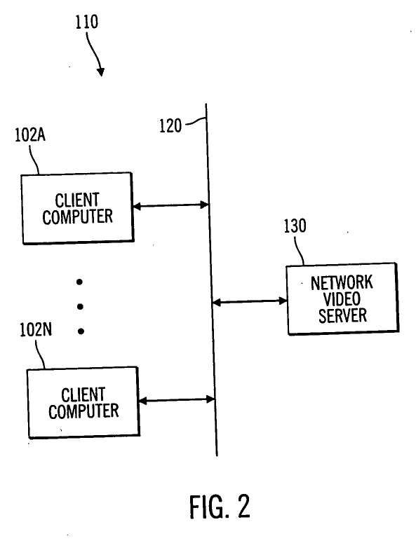

FIG. 1 is a simplified view of an exemplary client-server environment 100, such as the World Wide Web (the Web), in which the online digital video transfer method and apparatus may be implemented. The architecture of the Web follows a conventional client-server model. The terms “client” and “server” are used to refer to a computer's general role as a requester of data (the client) or provider of data (the server). Web clients 102 (102A, . . . , 102N) and Web servers 130 (130A, . . . 130N) communicate using a protocol such as HyperText Transfer Protocol (HTTP). In the Web environment, Web browsers reside on clients and render Web documents (pages) served by the Web servers. The client-server model is used to communicate information between clients 102 and servers 130. Web servers 130 are coupled to a network 120, for example the Internet, and respond to document requests and/or other queries from Web clients. When a user selects a document by submitting its Uniform Resource Locator (URL), a Web browser, such as Netscape Navigator or Internet Explorer, opens a connection to a server 130 and initiates a request (e.g., an HTTP get) for the document. The server 130 delivers the requested document, typically in the form of a text document coded in a standard markup language such as HyperText Markup Language (HTML) or Dynamic HTML (DHTML) In accordance with the client server environment depicted in FIG. 1, an online digital video signal transfer apparatus 110 may be implemented in online environment according to a first embodiment of the present invention as depicted in FIG. 2. The online environment includes one or more client computers 102 (102A, . . . , 102N) and at least one network server computer 130 connected by a communications link 120 to the plurality of client computers 102. The communications link 120 generally refers to any type of wire or wireless link between computers such as, but not limited to a local area network, a wide area network, or a combination of networks. In a preferred embodiment of the present invention the communications link can be a network such as the internet.

A client computer 102 can be any type of computing device such as but not limited to desktop computers, workstations, laptops and/or mainframe computers. One or more users not shown can be associated with each client computer 102.

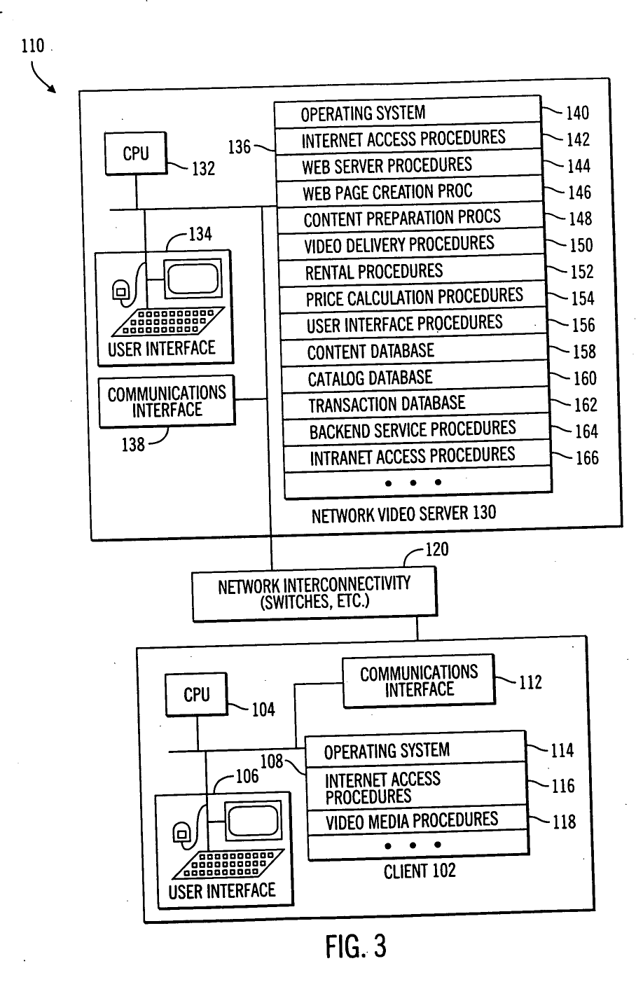

FIG. 3 illustrates the client computer 102 which includes a CPU 104, a user interface 106, a memory 108 and a communications interface 112. The communications interface 112 is used to communicate with a network video server computer 130 as well as other system resources not shown. The communications interface provides a network connection that is preferably a high speed or broadbrand data connection, such as a connection providing a data rate of one megabit per second (mbps) or more. The memory 108 of the client computer 102 may be implemented as RAM (random access memory) or a combination of RAM and non-volatile memory such as magnetic disk storage. The memory 108 preferably contains magnetic disk storage with at least one gigabyte of free space. The memory 108 can contain the following:
an operating system 114;
internet access procedures 116 including a Web-browser such as, for example, Internet Explore Version 4.0 or greater;
video media procedures 118;
as well as other procedures and files.

FIG. 3 also illustrates the network video server computer 130 which includes a central processing unit (CPU) 132, a user interface 134, a memory 136, and a communications interface 138. The network video server computer 130 can be any type of computing device such as but not limited to desktop computers, work stations, laptops, and/or main frame computers. The communications interface 138 is used to communicate with the client computers 102 as well as other system resources not shown.

The memory 136 of the network video server computer 130 may be implemented as RAM (random access memory) or a combination of RAM and non-volatile memory such as magnetic disk storage. Memory 118 can contain the following:
an operating system 140;
internet access procedures 142;
web server procedures 144;
web page creation procedures 146 that dynamically generate user web pages for registered users as well as movie web pages for one or more of the digital video signals available for rental from the network video server computer 130;
content preparation procedures 148, for encoding and encrypting original motion pictures;
video delivery procedures 150 for downloading digital video signals from the network video server computer 130 to the user computers 102;
rental procedures 152 for providing unlock encryption keys enabling viewing of downloaded digital video signals for a specified period of time;
price calculation procedures 154 for calculating and receiving electronic payment from users for a selected digital video signal;
user interface procedures 156 providing access to online catalog information regarding digital video signals available for rental from the network video server computer 130 including a movie search engine;
a content database 158 for storage of encoded and encrypted digital video signals available for download;
a catalog database 160 including information regarding digital video signals available for rental from the network video server computer 130;
a transaction database 162 for storage of information regarding user information as well as transaction information;
back end service procedures 164;
Intranet access procedures 166; and
Other procedures and data structures.
   Exemplary Online Video Transfer Site Interface

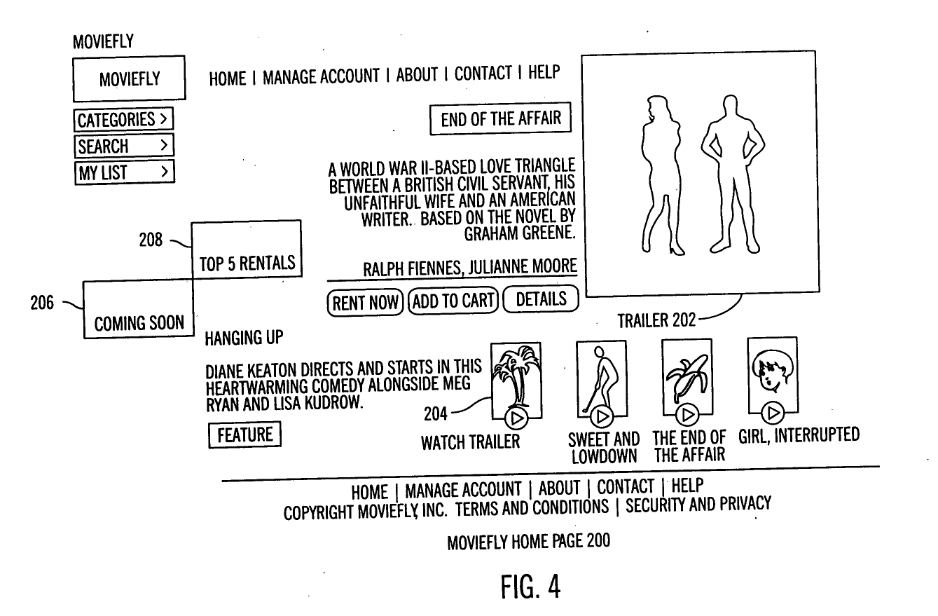

FIG. 4 depicts an exemplary online video transfer site screen that allows online users to rent digital video signals from the network video server computer 130. According to one embodiment, when a user wishes to participate in online rental of digital video signals, for example digitally encoded movies, the online user enters a MovieFly site and is presented with the MovieFly home page screen (movie home page) 200. The movie home page 200 provides access to online catalog information regarding various digital video signals available for rental from the network video server computer 130 (e.g., text which is also printed on a video cassette box for the movie, reviews of the movie, or comments from other users). The movie home page 200 also plays a trailer 202 of a featured selection 204 and includes additional information such as the coming soon area 206, listing of the top five rentals 208 in clips and stills of various digital video signals available for rental. From the movie home page 200, the online user is forwarded to various screens that allow the user to search and view various digital signals available for rental as well as the capability to download digital video signals for viewing on the user computer 102 at a later time.

As indicated above, the MovieFly home page 200 is the first page presented to a user upon entry into the MovieFly website. The home page 200 presents the trailer 202 from a movie selected by the MovieFly website. The trailer 202 begins playing (i.e., the video sequence begins) when the home page is accessed. The home page 200 also presents several movies to the user, such as by displaying an image and title for each movie, or by displaying an image of the front of a video cassette box for the movie. The home page 200 can also provide categories of information to the user, such as special or featured movies or a top 10 list of movies. The content of the movie home page 200 or other pages can be customized to the user. The user can enter into a commercial transaction to purchase a license for rental of the movie, such as by clicking on a video box or selecting a command.

The user can also access additional information about a movie through the video box, such as by mouse-clicking on the box or by selecting a command from a menu. The MovieFly website provides a distinction between selecting a movie for a commercial transaction and for accessing additional information, such as by right-click versus left-click or distinct menu commands. Upon accessing additional information for a movie, the movie website begins playing the trailer for or a clip from the movie. Examples of additional information available include images and audio from the movie, images and text from the video cassette box, reviews of the movie (e.g., by staff of the movie website, by third parties, by users of the movie website), or other links to websites related to the movie (e.g., a page in a movie index website, the official website for the movie sponsored by the owner of the movie, or the official website for the soundtrack of the movie).

A user can register with the Movie Fly website through the movie home page 200. Registration provides the user with enhanced access to the services of the MovieFly website, such as purchases. Additional services include the open order ticket and the MyList features. The open order ticket provides a user with a listing including one or more digital video signals the user has purchased for rental but has not yet unlocked for view. While the MyList feature provides the user with a listing including one or more digital video signals designated by the user as being of interest during a previous visit to the web site. Registration also provides a basis for customization of services to the user. Registration can provide to the movie website demographic and marketing information, as well as a basis for tracking user activity.

A categories page as described in further detail below, can be accessed from the movie home page. The categories page provides access to all the movies available on the server. The movies can be organized in various manners, such as by title, genre, license cost, or download time. The movies can be displayed in various ways as well, such as in text lists, image lists, video box lists, grids, or stacks. One manner of displaying movies is in a horizontal row of video boxes, which can be caused to slide to the left or right, simulating the action of a carousel. A user can interact with the movies presented on the browse page in the same way as those movies presented on the home page.

A search page can also be accessed from the movie home page 200. A user can search within the available movies of the MovieFly website according to various criteria, such as title, actor, director, producer, date, genre, license cost, or download time. The results of the search can be presented in various formats as well, similar to the movies presented on the browse page. Again, a user can interact with the movies presented on the search page in the same way as those movies presented on the home page.

The MovieFly website can also provide movie pages. A movie page is a web page serving as an access point to information about a movie. A movie page can include various information and functions, such as commercial transaction requests, or the additional information described above. A movie page can be accessed by selecting a movie and requesting the movie home page for the movie. The movie page presentation can provide a more consolidated and discrete presentation of information, rather than large amounts of information for multiple movies on a single page.

As described herein, a trailer refers to a clip (video segment) or collection of clips from a movie played when a user enters the MovieFly website or selects a movie in the MovieFly website. As described herein, virtual video boxes refers to a collection of images from a video cassette box forming an online graphical representation of virtual box of a video box. The image can be a direct image of the art and text on the physical box used for home video release, or can be a special online version. The carousel interface provides multiple virtual boxes or images presented in one or more rows which can be moved by the user. The boxes slide sideways with a continuously animated action and variable speed to simulate a rack or carousel being rotated before the user, including a continued rotation (or momentum) prior to coming to a complete stop. Alternatively, rotation of the multiple rows of boxes provides a user with a simulation of walking along racks of VHS video boxes along aisles within a video rental store.

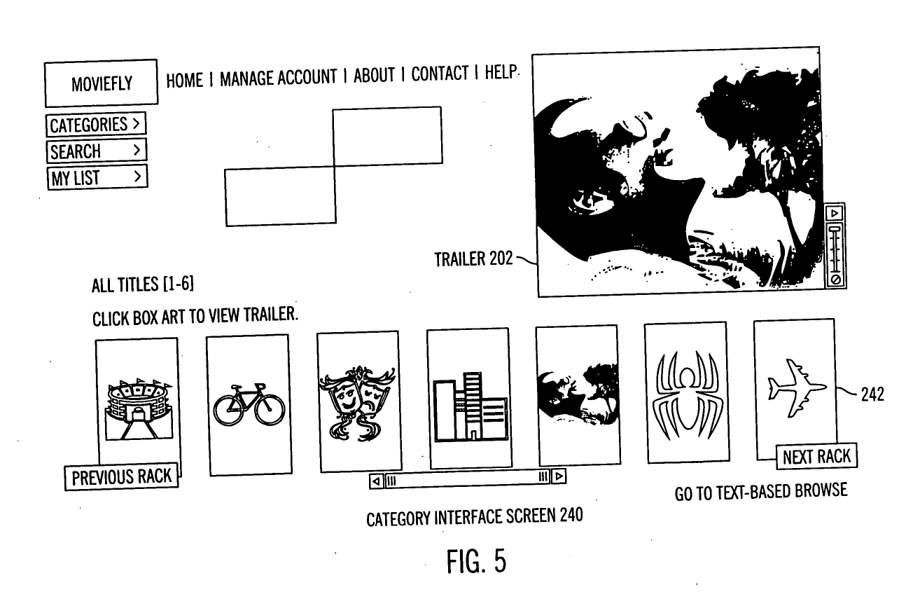

FIG. 5 is a further exemplary online video transfer site screen that allows online users to participate in online rental of digital video signals. According to one embodiment, when an online user makes a request the search and browse digital video signals available for online rental category interface screen 240 is presented. In accordance with one embodiment, the digital video signals are digitally encoded motion pictures such that information regarding each digitally encoded motion picture appears as a virtual video box including original box art as appears on a VHS version of the video box. Using the user interface procedures 156, the category interface screen 240 enables viewing of online category information stored in the catalog database 160. The category interface screen 240 enables scrolling rows of virtual box art one at a time or in a group within the carousel interface 242, such that movie rental from carousel of movies or from aisles of a video rental store is simulated. In addition, rows of virtual box art may be sorted based on sort criteria provided by the user to a movie search engine of the network server video computer 130. Advantageously, in this manner, the category interface screen 240 simulates movie rentals from racks of aisles within a video rental store.

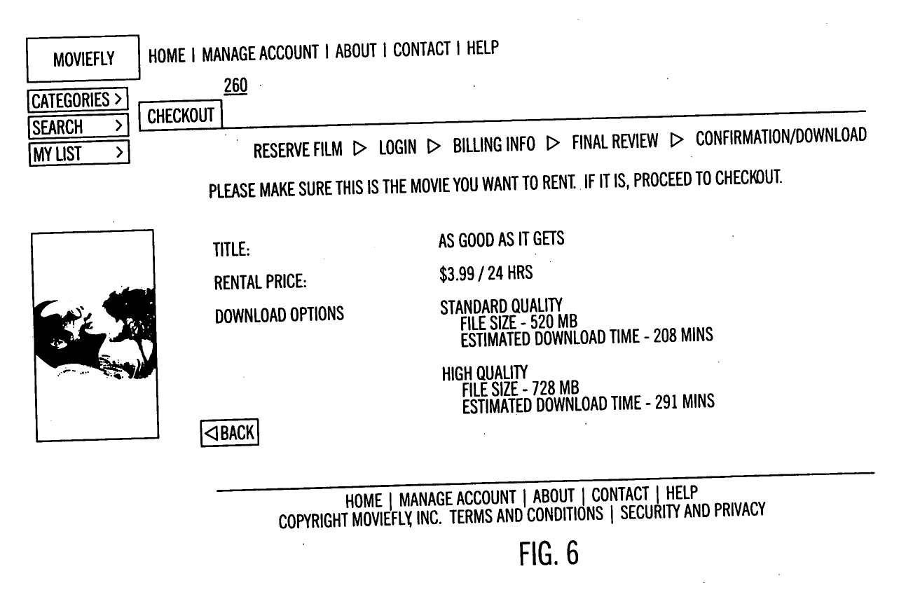

FIG. 6 is a further exemplary online video transfer site screen that allows online users to participate in online rental of digital video signals. According to this embodiment, when an online user selects a digital video signal for rental, checkout screen 260 is presented. Using the price calculation procedures 154, the checkout screen 260 calculates and receives electronic payment from the user for the selected digital video signal thereby granting the user a license to view the selected digital video signal for a specified period of time. The checkout screen 260 provides an interface for a commercial transaction, such as a form to be completed or queries to the user for credit card information and confirmation of billing to the user's credit card. The specified period of time is preferably a twenty-four hour period, which commences once the digital video signal is unlocked as further described below. Alternatively, the specified period of time may commence once downloading of the digital video signal is complete.

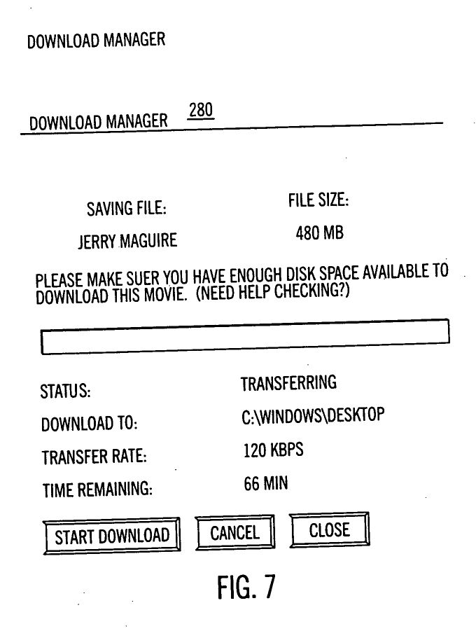

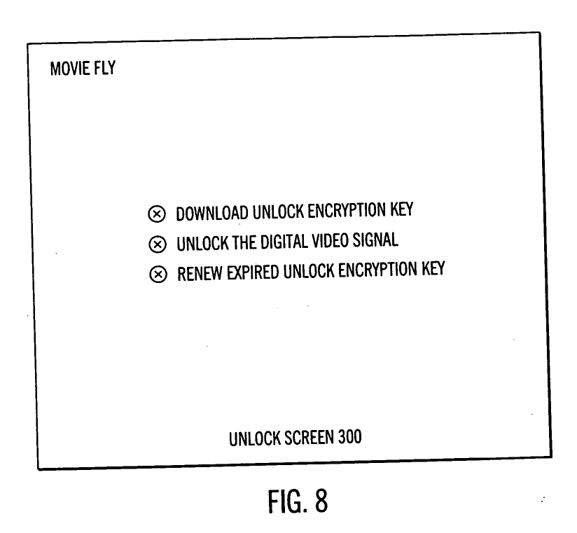

Once electronic payment is received, download screen 280 is presented as depicted in FIG. 7. The download screen provides users with the information regarding the file name and storage location for the downloaded digital video signal including the file size and duration time of the download. Using the video delivery procedures 150, the network video server computer 130 downloads an encrypted version of the digital video signal to the user computer 102. Once the user has downloaded the selected digital video signal, the user may view the selected digital video signal using the video media procedures 118, such as a Windows media player (movie player software 118). The movie player software 118 contacts the network video server computer 130 to verify that the user has a proper license for the selected digital video signal at which time an unlock screen 300 is presented as depicted in FIG. 8. In one embodiment, the unlock screen offers an online user the following options: (1) download an unlock encryption key; (2) unlock the digital video signal to enable viewing; and (3) renew an expired unlock encryption key. The unlock screen 300 provides an unlock encryption key enabling the movie player software 118 application to play the selected digital video signal during the specified period of time. The user can control playback similar to a VCR or DVD player utilizing pause, rewind, as well as other commands.

Operation

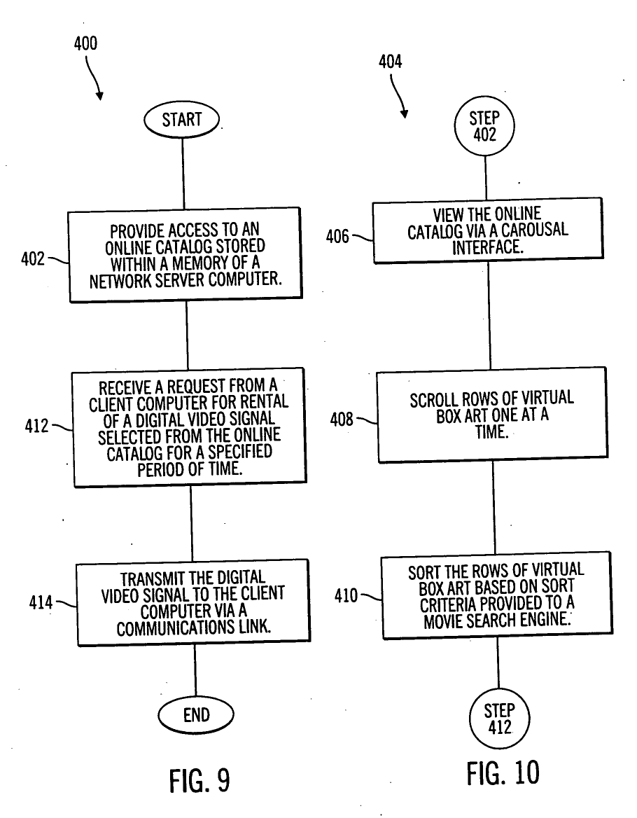

Referring now to FIG. 9, a method 400 is depicted for rental of digital video signals within an online environment, for example, in the online digital video signal transfer apparatus 110 as depicted in FIG. 1. At step 402, access is provided to an online catalog stored within a memory of a network video server computer 130 such as for example, the catalog database 160. The online catalog includes information regarding digital video signals available for rental from the network video server computer 130. At step 412, a request is received from a client computer 102 for rental of a digital video signal selected from the online catalog for a specified period of time. The request generally includes electronic payment based on the selected digital video signal and the specified period of time. Finally, at step 414, the digital video signal is transmitted to the client computer 102 via communications link 120. The digital video signal, once downloaded, is viewable by a user of the client computer during the specified period of time which begins once the digital video signal is unlocked as described below. Once the specified period of time is expired, the user must request and make further payments for viewing of the digital video signal for additional specified periods of time.

FIG. 10 depicts additional method steps 404 for providing access to online catalog information stored within the catalog database 160 of step 402, for example, in the category interface screen 240 as depicted in FIG. 5. At step 404, the online catalog is viewed via carousel interface 242 such that information regarding each digital video signal is presented within one or more vertically rotatable rows. In accordance with a further embodiment, the digital video signal is a digitally encoded motion picture, such that information regarding each digitally encoded motion picture appears as a virtual video box including original box art as appears on a VHS version of the motion picture box. At step 408, one or more rows of virtual box art are scrolled in a sliding, sideways manner one at a time or in a group, such that movie rental from a carousel of movies or from aisles of a video store is simulated. Finally, at step 410, the rows of virtual box art may be sorted based on sort criteria provided to a movie search engine of the network video server 130.

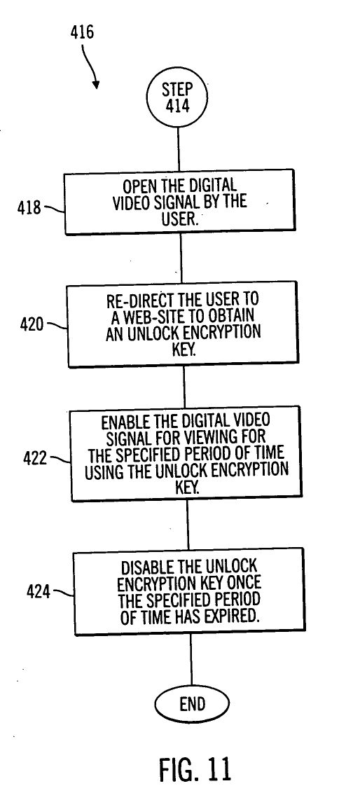

FIG. 11 depicts additional method steps 416, such that the digital video signal is encrypted prior to transmission to the client computer 102. At step 418 the digital video signal is opened by the user using the movie player software 118. At step 420 the user is redirected to a website to obtain an unlock encryption key such as the unlock screen 300 (FIG. 8) in accordance with the rental procedures 152. In one embodiment, the server 130 checks whether an unlock encryption key has been issued or activated for the movie to be accessed and requires a new license to be purchased to obtain additional keys. In accordance with the rental procedure 152, the unlock key becomes associated with the client machine 102, for example, through a system file of the client computer and data stored on the server 130 indicating the key and the downloaded copy of the movie. Association of the unlock key with the client computer 102 prevents users from copying the unlocked digital video signal to several computers for unlicensed usage.

At step 422 the digital video signal is enabled for viewing for the specified period of time using the unlock encryption key, such that the unlock key stores the time at which it was unlocked and initiates the specified period of time for rental. In one embodiment, the unlock encryption key can be activated at any time after being downloaded from the server 130. In this case, the time period does not begin until the key is activated. In addition, the unlock key stores a machine identifier such, for example a machine ID of the client computer 102. During the specified period of time, the unlock key verifies that the machine ID of the computer matches the stored machine ID in response to any user attempt to replay the digital video signal. Finally, at step 424, the unlock encryption key is disabled once the specified period of time has expired. The specified period of time is preferably a 24-hour period. Consequently, following the 24-hour period, the user is required to obtain an additional unlock encryption key in order to view the digital video signal for a further 24-hour period as described above with respect to the unlock encryption key.

A content database 158 provides storage including electronic video data files such as movies digitally encoded using a conventional encoding scheme such as MPEG 1, MPEG 2 or MPEG 4 in accordance with the content preparation procedures 148. Movies can be provided by one or more movie owners such as movie studios. The files are stored in a secure format such that the digitally encoded motion pictures are encrypted using conventional techniques such as a public-private key system.

Several aspects of one implementation of the movie transfer system for providing a movie to a user for viewing have been described. However, various implementations of the movie transfer system provide numerous features including, complementing, supplementing, and/or replacing the features described above. Features can be implemented as part of the server or as part of the user's computer system in different implementations.

It is to be understood that even though numerous characteristics and advantages of various embodiments of the present invention have been set forth in the foregoing description, together with details of the structure and function of various embodiment of the invention, this disclosure is illustrative only. Changes may be made in detail, especially matters of structure and management of parts within the principles of the present invention to the full extent indicated by the broad general meaning of the terms in which the appended claims are expressed. For example, the particular element may vary depending on the particular application for the novel mixed storage format while maintaining substantially the same functionality without departing from the scope and spirit of the present invention.

In addition, although the preferred embodiment described herein is directed to a video transfer system for enabling online rental of digitally encoded movies, it will be appreciated by those skilled in the art that the teaching of the present invention can be applied to other systems. In fact, systems for online rental of digitally encoded songs, books, television programming, radio programming, and any other content (audio, video, text, etc.) which can be digitized or encoded and stored as an electronic file are within the teachings of the present invention, without departing from the scope and spirit of the present invention.

The present invention provides many advantages over known techniques. The present invention includes the ability to rent motion pictures without having to provide additional monies for purchase of the motion pictures. In addition, the present invention provides an interface which simulates the actual rental of video cassettes or DVDs of motion pictures within a video rental store. Moreover, during the specified period of rental, the user is allowed to view the motion picture as many times as desired, thereby simulating the actual rental of video cassettes or DVDs of feature length motion pictures.

Having disclosed exemplary embodiments and the best mode, modifications and variations may be made to the disclosed embodiments while remaining within the scope of the invention as defined by the following claims.

What is claimed is:

1. A method for rental of digital video signals within an online environment comprising one or more client computers and at least one network video server computer connected by a communications link to the one or more client computers, the method comprising:
providing access to an online catalog stored within a memory of a network server computer, the online catalog including information regarding digital video signals available for rental from the network server computer;
receiving a request from a client computer for rental of a digital video signal selected from the online catalog for a specified period of time, the request including electronic payment based on the selected digital video signal and the specified period of time; and
transmitting the digital video signal to the client computer via a communications link, such that the digital video signal is viewable by a user of the client computer during the specified period of time.

2. The method of claim 1, wherein the providing access to the online catalog further comprises:
viewing the online catalog via a carousel interface, such that information regarding each digital video signal is presented within one or more horizontally rotatable rows.

3. The method of claim 2, wherein the digital video signal is a digitally encoded motion picture, such that the information regarding each digitally encoded motion picture appears as a virtual video box including original box art as appears on a VHS version of the virtual video box, the viewing the online catalog further comprising:
scrolling rows of virtual box art in a sliding, sideways manner, such that movie rental from aisles of a video rental store is simulated.

4. The method of claim 2, wherein the digital video signal is a digitally encoded motion picture, such that the information regarding each digitally encoded motion picture appears as a virtual video box including original box art as appears on a VHS version of the virtual video box, the viewing the online catalog further comprising:
scrolling a row of virtual box art in a sideways, continuously animated action and variable speed, such that a carousel or rack of video boxes rotating before a user is simulated.

5. The method of claim 2, wherein the digital video signal is a digitally encoded motion picture, such that the information regarding each digitally encoded motion picture appears as a virtual video box including original box art as appears on a VHS version of the virtual video box, the viewing the online catalog further comprising:
sorting the rows of virtual box art based on sort criteria provided by the user to a movie search engine of the network video server computer.

6. The method of claim 1, further comprising:
encrypting the digital video signal using an encryption key prior to the transmitting of the digital video signal to the client computer.

7. The method of claim 1, wherein the digital video signal is encrypted, further comprising:
opening the digital video signal by the user;
redirecting the user to a web site to obtain an unlock encryption key;
enabling the digital video signal for viewing for the specified period using the unlock encryption key; and
disabling the unlock encryption key once the specified period of time has expired.

8. The method of claim 7, wherein the enabling the digital video signal for viewing, further comprises:
storing a machine ID of the client computer; and
storing a current time in order to initialize the specified period of time, such that during the specified period of the unlock key utilizes compares a machine ID of a computer against the stored machine ID in response to user attempt to replay the digital video signal.

9. The method of claim 7, wherein the specified period is a twenty-four hour period, such that following the twenty-four hour period, the user is required to obtain an additional unlock encryption key in order to view the digital video signal for a further twenty-four hour period.

10. The method of claim 1, further comprising:
dynamically creating a user web page for each user based on information provided by each user during an initial registration at the network server; and
dynamically creating a movie web page for one or more of the digital video signals available for rental from the network server computer.

11. The method of claim 1, further comprising:
providing a user with a listing including one or more unlocked digital video-signals the user has purchased for rental.

12. The method of claim 1, further comprising:
providing a user with a listing including one or more digital video signals designated by the user as being of interest during a previous visit to the web site.

13. An online video signal transfer system for rental of digital video signals within an online environment comprising a plurality of client computers and at least one network server computer connected by a communications link to the plurality of client computers, the apparatus comprising:
a network server computer including an online catalog stored within a memory of the network server computer, the online catalog including information regarding digital video signals available for rental from the network server computer;
a plurality of users, each user associated with a particular computer client computer, each client computer configured to allow a user to request a digital video signal from the online catalog for rental of the digital video signal for a specified period of time, the request including electronic payment based on the selected digital video signal and the specified period of time; and
an online procedure for having a capability to receive the request and transmit the digital video signal to the client computer via a communications link, such that the digital video signal is viewable by the user of the client computer during the specified period of time.

14. The online video signal transfer system of claim 13, wherein the network server computer further comprises:
a carousel interface configured to allow users to view the online catalog via, such that information regarding each digital video signal is presented within one or more horizontally rotatable rows.

15. The online video signal transfer system of claim 13, wherein the network server computer further comprises:
a web page creation procedure having a capability to dynamically generate a user web page for each user based on information provided by each user during an initial registration at the network server, and dynamically generate a movie web page for one or more of the digital video signals available for rental from the network server computer.

16. The online video signal transfer system of claim 13, wherein the network server computer further comprises:
a digital video encryption procedure having a capability to encrypt each digital video signal available for rental from the network server computer using an encryption key; and
a digital video de-encryption procedure having a capability to provide a user with an unlock encryption key in response to the users attempt to view the digital video signal at the client computer, such that the unlock encryption key enables viewing of the digital video signal for the specified period requested by the user.

17. A computer readable storage medium that directs a computer to function in a specified manner, comprising:
an online catalog stored within a memory of a network server computer, the online catalog including information regarding digital video signals available for rental from the network server computer;
a plurality of users, each user associated with a particular computer client computer, each client computer configured to allow a user to request a digital video signal from the online catalog via a communications link for rental of the digital video signal for a specified period of time, the request including electronic payment based on the selected digital video signal and the specified period of time; and
an online procedure for having a capability to receive the request and transmit the digital video signal to the client computer via the communications link, such that the digital video signal is viewable by the user of the client computer during the specified period of time.

18. The apparatus of claim 17, further comprising:
a carousel interface procedure having the capability to allow users to view the online catalog via, such that information regarding each digital video signal is presented within one or more horizontally rotatable rows.

19. The apparatus of claim 17, wherein the digital video signal is a digitally encoded motion picture, such that the information regarding each digitally encoded motion picture appears as a virtual video box including original box art as appears on a VHS version of the virtual video box, the carousel interface procedure further comprising:
scrolling rows of virtual box art in a sliding, sideways manner, such that movie rental from aisles of a video rental store is simulated.

20. The apparatus of claim 17, wherein the digital video signal is a digitally encoded motion picture, such that the information regarding each digitally encoded motion picture appears as a virtual video box including original box art as appears on a VHS version of the virtual video box, the carousel interface procedure further comprising:
scrolling a row of virtual box art in a sideways, continuously animated action and variable speed, such that a carousel or rack of video boxes rotating before a user is simulated.

21. The apparatus of claim 17, wherein the digital video signal is a digitally encoded motion picture, such that the information regarding each digitally encoded motion picture appears as a virtual video box including original box art as appears on a VHS version of the virtual video box, the carousel interface procedure further comprising:
sorting the rows of virtual box art based on sort criteria provided by the user to a movie search engine of the network video server computer.

22. The apparatus of claim 17, further comprising:
a web page creation procedure having a capability to dynamically generate a user web page for each user based on information provided by each user during an initial registration at the network server, and dynamically generate a movie web page for one or more of the digital video signals available for rental from the network server computer.

23. The apparatus of claim 17, further comprising:
a digital video encryption procedure having a capability to encrypt each digital video signal available for rental from the network server computer using an encryption key; and
a digital video de-encryption procedure having a capability to provide a user with an unlock encryption key in response to the users attempt to view the digital video signal at the client computer, such that the unlock encryption key enables viewing of the digital video signal for the specified period requested by the user.

24. The apparatus of claim 17, wherein digital video de-encryption procedure further comprises:
opening the digital video signal by the user;
redirecting the user to a web site to obtain an unlock encryption key;
enabling the digital video signal for viewing for the specified period using the unlock encryption key; and
disabling the unlock encryption key once the specified period has expired.

25. The apparatus of claim 17, wherein the specified period is a twenty-four hour period, such that following the twenty-four hour period, the user is required to obtain an additional unlock encryption key in order to view the digital video signal for a further twenty-four hour period.
